(19) United States
(12) Patent Application Publication
(10) Pub. No.: US 2024/0396719 A1
(43) Pub. Date: Nov. 28, 2024

(54) QUANTUM KEY DISTRIBUTION (QKD) BASED SECURE COMMUNICATION SYSTEM USING ARTIFICIAL INTELLIGENCE

(71) Applicant: Richard D'souza, Langley (CA)

(72) Inventor: Richard D'souza, Langley (CA)

(21) Appl. No.: 18/322,707

(22) Filed: May 24, 2023

(51) Int. Cl. H04L 9/08

(52) U.S. Cl. CPC H04L 9/0852

(57) ABSTRACT

The present system relates to a quantum key distribution (QKD) based secure communication. The system includes a transmission device operatively coupled with a receiver device. The transmission device can create a quantum key, which is encrypted and transmitted over a secure communication channel, to the receiver device. The receiver device verifies integrity of the received encrypted quantum key and generates a random number, which can be utilized by transmission device to generate a shared key by using artificial intelligence module. The shared key is utilized to exchange communication data between the transmission device and receiver device by utilising QKD protocols.

### FIELD OF THE INVENTION

The present invention pertains to establish a secure communication. More specifically, a quantum key distribution (QKD) based secure communication using artificial intelligence.

### BACKGROUND

The background description includes information that may be useful in understanding the present invention. It is not an admission that any of the information provided herein is prior art or relevant to the presently claimed invention, or that any publication specifically or implicitly referenced is prior art.

In the realm of modern digital communication, secure data transmission is of utmost importance. As the volume of sensitive data exchanged across networks continues to escalate, so does the need for robust and reliable encryption and decryption mechanisms. These mechanisms safeguard personal information, financial transactions, corporate data, and even national security information from potential threats and cyber-attacks. Data encryption is the process of converting plaintext data into an unreadable format, or ciphertext, to prevent unauthorized access. The encrypted data can only be transformed back into its original form by decrypting it with the correct key. Therefore, the security of encrypted data heavily relies on the strength of the encryption algorithms and the confidentiality of the decryption keys.

However, these encryption algorithms and decryption keys are not impervious to threats. Traditional encryption methods could potentially be compromised by advanced cyber-attacks, brute-force key guessing, key theft, or even by advancements in computational power, particularly with the advent of supercomputer with superior computational capabilities, pose a significant threat to classical encryption algorithms.

Additionally, the secure transmission of the decryption keys themselves is a major challenge. These keys must be securely transmitted to the recipient for decryption to occur. Any interception or unauthorized access to these keys can potentially compromise the entire communication.

Quantum Key Distribution (QKD) mitigates aforementioned challenges and utilizes the principles of quantum mechanics to generate and distribute secure cryptographic keys. Traditional cryptographic systems rely on mathematical algorithms to secure data, but these algorithms can be vulnerable to attacks by sophisticated hackers or advances in computing power. QKD, on the other hand, is based on the principles of quantum mechanics, which provide a fundamentally secure means of generating and distributing cryptographic keys.

QKD relies on quantum entanglement, which refers to the correlation between two quantum systems such that the state of one system depends on the state of the other. In QKD, two parties, typically referred to as Alice and Bob, generate entangled photons and send them over a communication channel. The properties of the photons, such as their polarization or phase, are used to encode the cryptographic key. Any attempt to eavesdrop on the communication will disturb the photons and introduce errors into the key, alerting the parties to the presence of an eavesdropper.

Several QKD systems have been developed over the years, with varying degrees of practicality and performance. Early QKD systems were limited in their range and speed, making them impractical for commercial use. The recent advances in technology have led to the development of high-performance QKD systems that can operate over long distances and at high speeds.

Additionally, secure communication channels can be enhanced through the application of artificial intelligence (AI). AI algorithms can analyse data patterns, detect anomalies, and identify potential security threats in real-time, bolstering the integrity of the communication process. By leveraging machine learning techniques, AI can learn from past incidents and predict future attacks, enabling proactive defence. Additionally, AI-powered encryption algorithms can strengthen data protection, ensuring confidentiality during transmission. Through continuous monitoring and adaptive responses, AI can fortify communication channels against evolving cyber threats, safeguarding sensitive information and fostering trust in digital interactions. The integration of AI into secure communication channels establishes a robust defence mechanism that mitigates risks and promotes secure communication practices.

However, present QKD suffers from inadequate implementation of artificial intelligence, thereby several imitations limits for the full utilization of QKD potential. Thus, there remains a need for further contributions in this area of technology. More specifically, a need exists in the area of technology for quantum key distribution (QKD) based secure communication using artificial intelligence.

All references, including publications, patent applications, and patents, cited herein are hereby incorporated by reference to the same extent as if each reference were individually and specifically indicated to be incorporated by reference and were set forth in its entirety herein.

### SUMMARY

The present invention pertains to establish a secure communication. More specifically, a quantum key distribution (QKD) based secure communication using artificial intelligence.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

The following paragraphs provide additional support for the claims of the subject application.

In an aspect, present disclosure provides a quantum key distribution (QKD) based secure communication system, the system may include: a transmission device; a receiver device, wherein the receiver device is operatively coupled to the transmission device, through a secure communication channel; the transmission device: creates a quantum key; encrypts the created quantum key; and transmits the encrypted quantum key over the secure communication channel; the receiver device comprising receives the encrypted quantum key, from the transmission device, over the secure communication channel; verifies the integrity of the received encrypted quantum key; generates a random number; and transmits the random number to the transmission device.

In an aspect, the transmission device receives the random number transmitted by the receiver device; generates a shared key based on the received random number, wherein the shared key is generated using an artificial intelligence (AI) based key generation module; verifies the integrity of the generated shared key; and transmits the shared key to the receiver device.

In an aspect, the receiver device further receives the shared key, transmitted by the transmission device; verifies the integrity of the received shared key; and encrypts and/or decrypts communication data, and exchanges with the transmission device.

In an aspect, AI-based key generation module collects data generated during the QKD process; utilises AI-based key generation algorithm to process the gathered data and generates a random set of unique and secure keys; and stores the generated random set of unique and secure keys to enable the secure communication between the transmission device and the receiver device.

In an aspect, a secure key management unit ensures security of the random set of unique and secure keys, wherein the secure key management unit: regulates access of the random set of unique and secure keys, wherein the access control module authenticates a sender and/or a receiver based on a predefined access criterion, to allow access of the stored random set of unique and secure keys; manages lifecycle of the stored random set of unique and secure keys; and detects and reports at least one selected from: a security threat, an unauthorized access attempt, a suspicious activity related to the generated random set of unique and secure keys.

In an aspect, a secure authentication protocol may utilize a public key cryptography mechanism to authenticate the sender and/or the receiver.

In an aspect, present disclosure provides a method for managing quantum key distribution (QKD) based secure communication, the method comprising: utilising a transmission device for: generating a key at the transmission device; encrypting the generated key; and transmitting the encrypted key over a secure communication channel; operatively coupling the transmission device to a receiver device, through the secure communication channel; utilising a receiver device for: verifying the integrity of the received encrypted key; generating a random number using a random number generator; and transmitting the random number to the transmission device.

In another embodiment, the receiver device receives the shared key, verifies integrity thereof, to encrypt and/or decrypt communication data, which is then exchanged with the transmission device.

### BRIEF DESCRIPTION OF THE DRAWINGS

Embodiments will now be described in more detail in relation to the enclosed drawings, in which:

FIG. 1 depicts a quantum key distribution (QKD) based secure communication system, in accordance with embodiment of present disclosure.

FIG. 2 illustrates an exemplary flow chart of a method for managing secure communication using QKD, in accordance with an embodiment of present disclosure.

FIG. 3 portrays an exemplary computing resource, in accordance with an embodiment of present disclosure.

### DETAILED DESCRIPTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The present invention pertains to establish a secure communication channel. More specifically, a quantum key distribution (QKD) based secure communication using artificial intelligence.

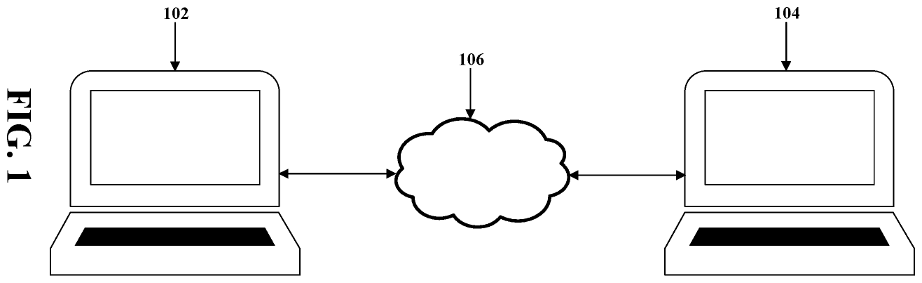

Referring now to the invention in more detail, FIG. 1 depicts a quantum key distribution (QKD) based secure communication system 100, in accordance with an embodiment of present disclosure. The QKD system 100 facilitates secure communication between a transmission device 102 and a receiver/receiving device 104, through the exchange of cryptographic keys over a secure communication channel 106. The transmission device 102 and receiver device 104 can be operatively coupled with each other, through the secure communication channel 106.

The transmission device 102 may create a quantum encryption key. The transmission device 102 may encrypt the created quantum key, whereas any encryption mechanism can be, including but not limited to, Rivest-Shamir-Adleman, Advanced Encryption Standard, Data Encryption Standard, Triple DES, Blowfish and Twofish, ElGamal, Diffie-Hellman, Elliptic Curve Cryptography and Quantum Key Distribution. The encryption of key ensures that the communication between the transmission device 102 and receiving device 104 remains confidential and secure.

The transmission device 102 may transmit the encrypted quantum key over the secure communication channel 106. To ensure secure transmission, the transmission device 102 may employ quantum communication protocols, particularly QKD, which can enable the secure exchange of cryptographic keys. The QKD 100 can be resistant to eavesdropping or tampering attempts by detecting any unauthorized access or interference.

In an embodiment, upon detection of attack, the QKD protocol issues an alert to the transmission device 102 and/or receiving device 104, indicating generated key is compromised, and suggests generation of a new key. Aforementioned process can be repeated until secure key is successfully exchanged, ensuring the integrity and confidentiality of the key throughout transmission.

In an embodiment, the receiver device 104 can receive the encrypted key, from the transmission device 102, over the secure communication channel 106. The receiver device 104 can verify the received quantum encrypted key, for integrity check, through any mechanism such as Diffie-Hellman Key Exchange, Public Key Infrastructure, Kerberos, Rivest-Shamir-Adleman, Transport Layer Security, Secure Sockets Layer and Message Authentication Code.

The integrity check ensures that the received key is untampered during the transmission over the secure communication channel 106. Also, integrity check indicates for error detection through utilization of correction algorithms and the principles of quantum mechanics. Such error-correcting codes like the Hamming code or Reed-Solomon code, can identify and correct any errors that may have occurred during the transmission of the key.

In an embodiment, the receiving device 104 may incorporate a random number generator to further bolster the security of the communication between the transmission device 102 and receiver device 104. The random number functions as a nonce, which stands for “number used once.” A nonce is a unique value employed in cryptographic protocols to ensure the freshness of each communication, thereby preventing replay attacks. Notably, the random number generator can be selected from any or a combination of True Random Number Generators (TRNGs) or a Pseudorandom Number Generators (PRNGs). The TRNG can generate numbers from a truly random and a non-deterministic source, whereas PRNG can generate numbers that only appear to be random and then generates a sequence of numbers that are random. The PRNG can use Cryptographically Secure Pseudorandom Number Generators (CSPRNGs) which possess two main properties i.e. Next-bit unpredictability and backtracking resistance. Exemplary CSPRNGs may include the Fortuna algorithm, the Yarrow algorithm, and the like.

The generated random number can be transmitted by the receiver device 102, to the transmission device 102, through the secure channel 106.

In an aspect, the transmission device 102, may receive the generated random number. The received random number can be utilized to generate a shared key, whereas the artificial intelligence or machine learning mechanism can be employed to generate the shared key. The generated key can be verified, thereafter transmitted to the receiver device 104, over the secure channel 106. The shared key generation process may involve cryptographic algorithms, such as symmetric key algorithms, which use a combination of the initial key and the random number to derive a unique, shared key for secure communication.

In an embodiment, the receiver device 104, upon receiving the shared key, can perform integrity check. Upon successful verification of shared key's integrity, the receiver device 104 can decrypt the key using the decryption algorithm. With the decrypted key, the receiving device 104 can securely communicate with the transmission device 102, exchanging communication data, over the secure channel 106. Exchange of encryption key, shared key, random number, and the like may utilize QKD communication protocol.

QKD is a secure key exchange protocol that capitalizes on the quantum mechanics to facilitate the secure transmission of cryptographic keys, the random number, communication data between the transmission device 102 and receiver device 104. QKD ensures that any attempt to intercept or tamper with the transmitted information during the process is detected and dealt accordingly.

In an embodiment, the QKD system 100 may incorporate an artificial intelligence (AI) based key generation module to gather/collect data during a QKD processing. The artificial intelligence (AI)-based key generation module uses one or more artificial algorithms to process gathered data to generate a random set of unique and secure keys. The AI-based key generation module can be integrated into either the transmission device 102 and/or the receiving device 104.

Exemplary gathered data may include transmitted information, error rates, and other parameters that characterize the performance and security of the QKD process. The AI-based key generation algorithm may employ machine learning techniques and advance cryptographic algorithms to ensure the generated keys' randomness, uniqueness, and security. The AI-based key generation algorithm can produce keys that are resistant to computational attacks, providing a higher level of security.

In an embodiment, the AI-based key generation module may incorporate a key storage module to store the generated random set of unique and secure keys. These keys can be utilized for subsequent secure communication between the transmission device 102 and the receiver device 104. The key storage module may use secure memory storage technologies, such as hardware security modules (HSMs), to protect the stored keys from unauthorized access, tampering, or theft.

In an embodiment, a secure key management unit may form part of the QKD system 100 to manage security of the random set of unique and secure keys, thereby prevent unauthorized access. The secure key management unit can be integrated into the transmission device 102 and/or receiving device 104.

In an embodiment, the secure key management unit may include an access control module, which regulates access to the stored random set of unique and secure keys within the secure key management system. The access control module is configured to authenticate sender and/or receiver based on predefined access criteria, granting access to the stored random set of unique and secure keys only to authorized users. The authentication process may involve the use of digital certificates, biometric authentication, or multi-factor authentication mechanisms to ensure that only authorized users can access the keys.

In an embodiment, the secure key management unit includes a key lifecycle management module that manages lifecycle of the random set of unique and secure keys. The key lifecycle management module oversees key generation, distribution, usage, rotation, and deletion in accordance with predefined security policies and procedures. By managing the lifecycle of the keys, the key lifecycle management module helps to maintain the keys' security, ensures their proper use, and prevents vulnerabilities due to outdated or compromised keys.

In an embodiment, the secure key management unit features a security monitoring module that detects and reports a security threat, an unauthorized access attempt, or other suspicious activities related to the stored random set of unique and secure keys. The security monitoring module continuously monitors key access and usage patterns, initiating predefined countermeasures to mitigate risks associated with detected threats or activities. These countermeasures may include alerting system administrators, revoking access rights, or initiating key rotation procedures.

In an embodiment, the QKD system 100 may further incorporate a secure authentication protocol that utilizes public key cryptography for authenticating sender and/or receiver and ensuring that the keys are used by the authenticated sender and/or receiver. The secure authentication protocol can be integrated into the transmission device 102, the receiver device 104, or both.

In the context of the secure authentication protocol, both the transmission device 102 and the receiver device 104 may generate their own public and private key pairs. The public keys are openly shared between the devices 102 and 104, while the private keys are kept secret and securely stored within the devices.

In an embodiment, to authenticate sender and/or receiver and ensure the integrity of the communication, the transmission device 102 digitally signs communication data/message using its private key before transmission. The receiver device 104 then verifies the digital signature using the transmission device's 102 public key. If the verification is successful, the receiver device 104 can be sure that the message transmitted from the transmission device 102 has not been tampered during transmission.

In an embodiment, during the key exchange process, the transmission device 102 and the receiving device 104 may utilize public key cryptography to securely exchange the quantum-generated keys. The keys are encrypted using the public key, ensuring that only the intended recipient can decrypt and access the keys using their private key. The encryption process provides an additional layer of security to the key exchange process and prevents unauthorized access to the keys.

In an embodiment, the AI-based encryption module encrypts the data using the selected encryption algorithm and the appropriate keys. The module takes into account the unique properties of the quantum-generated keys and leverages cryptographic techniques to provide strong encryption that is resistant to attacks, even from quantum computers.

In an embodiment, the AI-based quantum encryption module is also capable of decrypting message. By utilizing the corresponding decryption algorithm and the appropriate keys, the module is able to decrypt the data, ensuring secure and accurate communication between the transmission device 102 and the receiver device 104.

Exemplary case can be understood as sender may log into the QKD system 100 with their credentials and enters their encryption key, whereas the encrypted key can be stored in a database. The sender sets access controls and permission levels for the key, thereby prevents unauthorized key access. The system 100 logs all access attempts to the key. The system 100 allows access revoke to the key at any time, and securely deletion of the key. The transmission device 102 can be associated with sender and receiver device 104 with receiver.

Another exemplary case can be logging into the system 100 using username and password. Upon successful verification of credentials, QKD system 100 generates a public and private key pair, whereas public key is transmitted to the user. Additionally, the message can be encrypted using the public key and decrypted using the private key. The QKD system 100 may verify authenticity by comparing the message to the stored credentials. The system 100 may grant access, if the credentials match.

In one more exemplary case, the secure communication channel 106 can be established between the transmission device 102 and receiver device 104, using a trusted third party, such as QKD 100. The authentication codes can be generated using the quantum keys, which can be exchanged in advance. The devices 102 and 104 may verify the authentication codes, if codes are matched, devices 102 and 104 are authenticated.

In an exemplary implementation, data to be encrypted can be provided. The AI mechanism can use quantum encryption algorithm to encrypt the data, based on which unique keys can be generated. The AI mechanism can use the keys to encrypt the data, whereas encrypted data can be stored on a secure server. The encrypted data can be accessible only with the generated keys. Message can be decrypted via the keys. The encryption algorithm can be updated periodically to ensure data security.

The artificial intelligence (AI) based key generation module, access control module, key storage module, key lifecycle management module, security monitoring module and AI-based quantum encryption module can be a hardware and/or software-based implementation. The software-based implementation can be executed by a processing unit or a microcontroller.

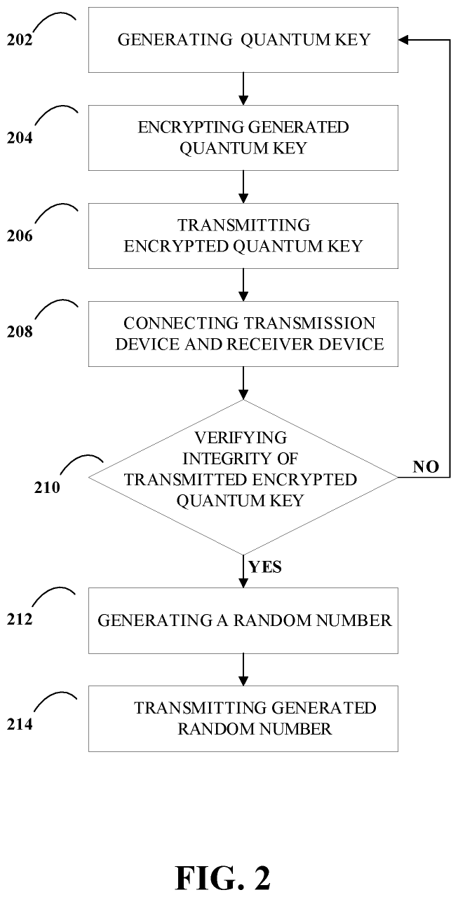

FIG. 2 illustrates an exemplary flow chart 200 of a method for managing secure communication using QKD. This method:

Step 202: involves the utilization of a transmission device 102 that is capable of generating a quantum key. The quantum key is generated using quantum principles, which ensures the key's uniqueness and unpredictability. The quantum key forms the basis of the secure communication between the transmission and receiver device 104.

Step 204: involves encryption of generated quantum key. Encryption can be achieved using quantum encryption algorithms, ensuring that the key remains secure during transmission. The encryption transforms the key into an unintelligible format, which can only be decrypted by the appropriate decryption algorithm.

Step 206: involves the transmission of the encrypted quantum key over secure communication channel 106 that can be any quantum-enabled communication pathway, such as a fiber optic cable or a free space channel for satellite-based quantum communication. The secure communication channel 106 ensures that the integrity and confidentiality of the key are maintained during transmission.

Step 208: describes connection between the transmission device 102 and a receiver device 104 via the secure communication channel 106. This operative coupling enables the secure transfer of the encrypted key from the transmission device 102 to the receiver device 104.

Step 210: describes integrity verification of the transmitted encrypted quantum key. The receiver device 104, which could be another quantum-enabled device, receives the encrypted quantum key (from transmission device 102) and verifies its integrity. The integrity verification process ensures that the key has not been tampered with or altered during transmission. The integrity verification can be accomplished through the use of a cryptographic checksum or hash function using combination of classical and quantum techniques. Briefly, the receiver device 104 compute checksum or hash from encrypted quantum key and compares with the transmitted checksum or hash value. If the two values matches, the integrity of the data is confirmed. If they don't match, this indicates that the data has been altered during transmission, either due to an error or malicious activity. Upon failure to verification (which can be signified of eavesdropping), the received encrypted quantum key can destroy and request the transmission device 102 to start process again at step 202.

Step 212: describes process of generation of a random number (at receiver device, upon successful verification at step 210) using a random number generator. This random number generation is crucial as it further strengthens the security of the QKD process.

Step 214: illustrates transmission of generated random number to the transmission device 102 over the secure communication channel 106. This serves as an acknowledgment of the successful receipt and verification of the encrypted key and signals the readiness of the receiver device 104 for further secure communication.

In a preceding embodiment, the Quantum Key Distribution (QKD) can be a process that allows two parties, typically referred to as Alice and Bob, to securely exchange encryption keys by using the principles of quantum mechanics. The generation of random sets of keys from QKD data is an important step in ensuring secure communication. Here is an elaboration on the mentioned algorithms namely Blinding Protocol, Cascade Protocol, Information Reconciliation Protocol, Privacy Amplification Protocol and SARG04 Protocol.

In the binding protocol, the random numbers generated from the QKD process serve as a key. Alice sends Bob a randomly chosen bit string, and Bob selects a random subset of those bits to commit to. Bob reveals his choice, and Alice proves she knew the values of the committed bits without revealing the uncommitted bits. The aforementioned method offers security by providing a mechanism for generating random numbers that are both unpredictable and unbiased.

In an embodiment, the cascade protocol is an iterative, multi-stage algorithm designed to produce a final shared key from the raw key material obtained through the QKD process. The QKD process involves multiple rounds of error correction and privacy amplification to eliminate errors and remove any potential eavesdropping attempts. By performing repeated rounds of comparisons and corrections, the protocol ensures that Alice and Bob's keys are identical, while minimizing the information revealed to an eavesdropper.

In an embodiment, information reconciliation protocol addresses the discrepancies that may arise in the raw key material generated by the QKD process on Alice's and Bob's ends due to transmission errors or other factors. The information reconciliation protocol employs error-correcting codes and interactive communication between the two parties to ensure they both have the same key material while minimizing information leakage.

In an embodiment, privacy amplification protocol focuses on extracting a final shared key from the raw key material produced by the QKD process. The privacy amplification protocol uses hash functions to reduce the length of the key material, thereby removing any remaining errors and traces of eavesdropping attempts. By employing hash functions, the protocol ensures that an eavesdropper cannot gain knowledge of the final key, even if they possess partial information about the raw key material.

In an embodiment, the SARG04 Protocol (named after its creators Scarani, Acin, Ribordy, and Gisin) uses Toeplitz matrices to create a final shared key from the raw key material generated during the QKD process. Toeplitz matrices have a constant diagonal, which helps ensure that the generated random numbers and the final shared key are unbiased and unpredictable. The SARG04 Protocol provides a secure method for generating random numbers and is resistant to photon-number-splitting attacks, a common vulnerability in QKD systems.

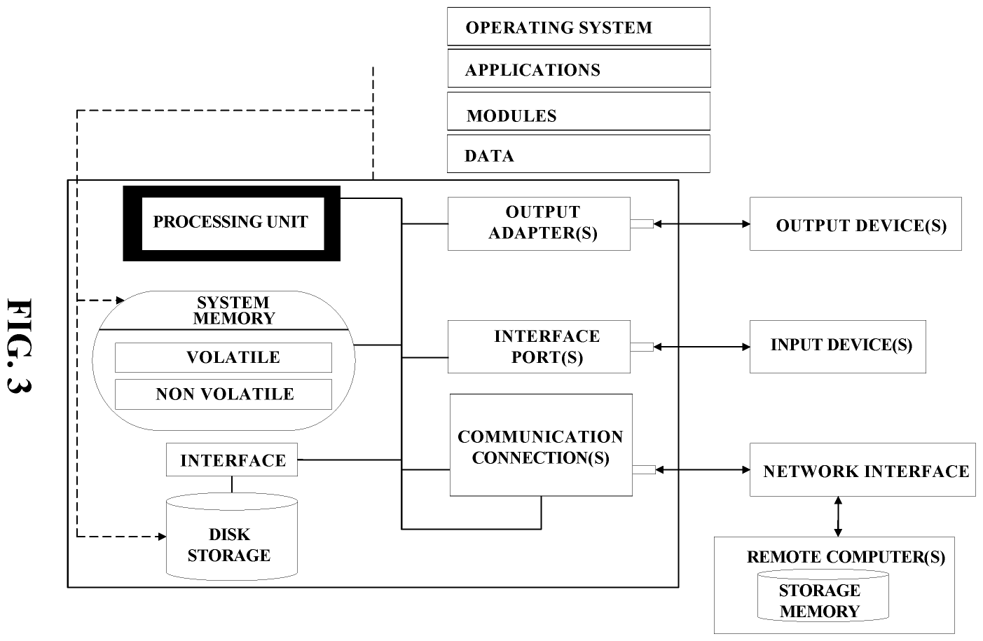

FIG. 3 portrays an exemplary computing resource that can be deployed for QKD based secure communication system, in accordance with the embodiments of the present disclosure. The computer resources may include a processing unit (e.g., CPU, processor etc.), input device, output device (e.g., monitors, speakers, printer), a memory (e.g., RAM, ROM, CD-ROM, DVD-ROM, removable or non-removable data storage medium), and a system bus that can be configured for coupling of the components such as memory, processing unit, etc. The system bus can be selected from a peripheral bus or external bus, 8-bit bus, Industrial Standard Architecture (ISA), Micro-Channel Architecture (MSA), Extended ISA (EISA), and any variety of available bus architectures to enable highspeed data transfer. The memory can comprise firmware or software or operating environment that acts as an intermediary link between users and the basic computer hardware. Generally. Users provide input or commands to the computing resource through input device (e.g., mouse, trackball, stylus, touch pad, keyboard, microphone, joystick, remote control, and the like). The input device can be connected to the processing unit through the system bus via interface port (e.g., universal serial bus (USB) port, serial port, parallel port etc.). The computing resource can operate in a networked environment using logical connections to one or more remote computers, such as remote computer (e.g., personal computer, a server, a router, a network PC, a workstation, other common network node and the like) through network interface such as local-area networks (LAN), wide-area networks (WAN). WIFI, Bluetooth and the like. The computing resource may additionally comprise necessary hardware (e.g., modems including regular telephone grade modems, cable modems and DSL modems, ISDN adapters, and Ethernet cards) and associated software, which can be necessary for connection to the network interface.

Throughout the present disclosure, the term “communication channel” relates to any collection of networks using standard protocols. For example, the term includes a collection of interconnected (public and/or private) networks that are linked together by a set of standard protocols (such as TCP/IP, HTTP, and FTP) to form a global, distributed network. While this term is intended to refer to what is now commonly known as the Internet®, it is also intended to encompass variations that may be made in the future, including changes and additions to existing standard protocols or integration with other media (e.g., television, radio, etc). The term is also intended to encompass non-public networks such as private (e.g., corporate) Intranets. As used herein, the terms “World Wide Web” or “web” refer generally to both (i) a distributed collection of interlinked, user-viewable hypertext documents (commonly referred to as Web documents or Web pages) that are accessible via the Internet®, and (ii) the client and server software components which provide user access to such documents using standardized Internet® protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols that may be used in place of (or in addition to) HTML and HTTP.

Throughout the present disclosure, the term ‘Artificial intelligence (AI)’ as used herein relates to any mechanism or computationally intelligent system that combines knowledge, techniques, and methodologies for controlling a bot or other element within a computing environment. Furthermore, the artificial intelligence (AI) is configured to apply knowledge and that can adapt it-self and learn to do better in changing environments. Additionally, employing any computationally intelligent technique, the artificial intelligence (AI) is operable to adapt to unknown or changing environment for better performance. The artificial intelligence (AI) includes fuzzy logic engines, decision-making engines, pre-set targeting accuracy levels, and/or programmatically intelligent software.

Artificial intelligence (AI) in the context of the present disclosure relates to software-based algorithms that are executable upon computing hardware and are operable to adapt and adjust their operating parameters in an adaptive manner depending upon information that is presented to the software-based algorithms when executed upon the computing hardware. Optionally, the artificial intelligence (AI) includes neural networks such as recurrent neural networks, recursive neural networks, feed-forward neural networks, convolutional neural networks, deep belief networks, and convolutional deep belief networks; self-organizing maps; deep Boltzmann machines; and stacked de-noising auto-encoders. An “artificial neural network” or simply a “neural network” as used herein can include a highly interconnected network of processing elements, each optionally associated with a local memory. In an example, the neural network may be Kohonen map, multi-layer perceptron and so forth. The processing elements can be referred to herein as “artificial neural units,” “artificial neurons,” “neural units,” “neurons,” “nodes,” and the like, while connections between the processing elements. A neuron can receive data from an input or one or more other neurons, process the data, and send processed data to an output or yet one or more other neurons. The neural network or one or more neurons thereof can be generated in either hardware, software, or a combination of hardware and software, and the neural network can be subsequently trained.

Optionally, artificial intelligence (AI) employs any one or combination of the following computational techniques: constraint program, fuzzy logic, classification, conventional artificial intelligence, symbolic manipulation, fuzzy set theory, evolutionary computation, cybernetics, data mining, approximate reasoning, derivative-free optimization, decision trees, or soft computing.

A number of implementations have been described. Nevertheless, various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors Executable instructions stored on the computer-readable media or memory can include, for example, an operating system, a data management framework, and/or other modules, programs, or applications that are loadable and executable by the processor(s) or any appropriate hardware logic components/CPU(s).

It will be obvious to a person skilled in the art that, as technology advances, the inventive concept can be implemented in various ways. The above-described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

Conditional language such as, among others, include”, “including”, “comprise”, “comprising”, “can,” “could,” “might” or “may,” unless specifically stated otherwise, is understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any example. Conjunctive language such as the phrase “at least one of X, Y or Z,” unless specifically stated otherwise, is to be understood to present that an item, term, etc. may be any of X, Y, or Z, or a combination or sub-combination thereof. As described above, the exemplary embodiment provides both a method and corresponding apparatus consisting of various modules providing functionality for performing the steps of the method. The modules/engines may be implemented as hardware (embodied in one or more chips including an integrated circuit such as an application specific integrated circuit) or may be implemented as software or firmware for execution by a computer processor. In the case of firmware or software, the exemplary embodiment can be provided as a computer program product including a computer readable storage structure embodying computer program code (i.e., software or firmware) thereon for execution by the computer processor.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Many different embodiments have been disclosed herein, in connection with the above description and the drawings. It will be understood that it would be unduly repetitious and obfuscating to literally describe and illustrate every combination and sub-combination of these embodiments. Accordingly, all embodiments may be combined in any way and/or combination, and the present specification, including the drawings, shall be construed to constitute a complete written description of all combinations and sub-combinations of the embodiments described herein, and of the manner and process of making and using them, and shall support claims to any such combination or sub-combination.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

I/We claim:

1. A quantum key distribution (QKD) based secure communication system, the system comprising:
a transmission device;
a receiver device, wherein the receiver device is operatively coupled to the transmission device, through a secure communication channel;
the transmission device:
creates a quantum key;
encrypts the created quantum key; and
transmits the encrypted quantum key over the secure communication channel;
the receiver device comprising:
receives the encrypted quantum key, from the transmission device, over the secure communication channel;
verifies integrity of the received encrypted quantum key;
generates a random number; and
transmits the random number to the transmission device.

2. The quantum key distribution (QKD) based secure communication system of claim 1, wherein the transmission device:
receives the random number transmitted by the receiver device;
generates a shared key based on the received random number, wherein the shared key is generated using an artificial intelligence (AI) based key generation module;
verifies integrity of the generated shared key; and
transmits the shared key to the receiver device.

3. The quantum key distribution (QKD) based secure communication system of claim 2, wherein the receiver device further:
receives the shared key, transmitted by the transmission device;
verifies integrity of the received shared key; and
encrypts and/or decrypts communication data, and exchanges with the transmission device.

4. The quantum key distribution (QKD) based secure communication system of claim 2, wherein the AI-based key generation module comprises:
collects data generated during the QKD process;
utilises an AI-based key generation algorithm to process the gathered data and generates a random set of unique and secure keys; and
stores the generated random set of unique and secure keys to enable the secure communication between the transmission device and the receiver device.

5. The quantum key distribution (QKD) based secure communication system of claim 1, further comprising a secure key management unit to ensure security of the random set of unique and secure keys, wherein the secure key management unit:
regulates access of the random set of unique and secure keys, wherein the access control module authenticates a sender and/or a receiver based on a predefined access criterion, to allow access of the stored random set of unique and secure keys;
manages lifecycle of the stored random set of unique and secure keys; and
detects and reports at least one selected from: a security threat, an unauthorized access attempt, a suspicious activity related to the generated random set of unique and secure keys.

6. The quantum key distribution (QKD) based secure communication system of claim 5, further comprising a secure authentication protocol to utilize a public key cryptography mechanism to authenticate the sender and/or the receiver.

7. A method for managing quantum key distribution (QKD) based secure communication, the method comprising:
utilising a transmission device for:
generating a key at the transmission device;
encrypting the generated key; and
transmitting the encrypted key over a secure communication channel;
operatively coupling the transmission device to a receiver device, through the secure communication channel;
utilising a receiver device for:
verifying the integrity of the received encrypted key;
generating a random number using a random number generator; and
transmitting the random number to the transmission device.

8. The method of claim 7, wherein the transmission device is arranged for:
receiving a random number, transmitted from the receiver device;
generating a shared key based on the received random number, wherein the shared key is generated using an artificial intelligence (AI) based key generation module;
verifying the integrity of the generated shared key; and
transmitting the shared key to the receiver device.

9. The method of claim 7, wherein employing a quantum random number generation for generating a shared key.

10. The method of claim 7, utilises a quantum encryption algorithm for secure encryption of the generated key.

11. A non-transitory computer-readable storage medium, comprising executable instructions that, when executed by a processing system including a processor, facilitate security management of quantum key distribution (QKD) based secure communication, comprising:
utilising a transmission device for:
generating a key at the transmission device;
encrypting the generated key; and
transmitting the encrypted key over a secure communication channel;
operatively coupling the transmission device to a receiver device, through the secure communication channel;
utilising a receiver device for:
verifying the integrity of the received encrypted key;
generating a random number using a random number generator; and
transmitting the random number to the transmission device.
